(19) United States
(12) Patent Application Publication
(10) Pub. No.: US 2015/0015833 A1
(43) Pub. Date: Jan. 15, 2015

(54) CELLULOSE ACYLATE FILM AND METHOD FOR PRODUCING THE SAME

(71) Applicant: FUJIFILM Corporation, Tokyo (JP)

(72) Inventors: Jun TAKEDA, Kanagawa (JP); Taku WAKITA, Kanagawa (JP); Takashi TAMADA, Kanagawa (JP)

(73) Assignee: FUJIFILM CORPORATION, Tokyo (JP)

(21) Appl. No.: 14/499,880

(22) Filed: Sep. 29, 2014

Related U.S. Application Data
(63) Continuation of application No. PCT/JP2013/057046, filed on Mar. 13, 2013.

(30) Foreign Application Priority Data
Mar. 30, 2012 (JP) 2012-081901

(51) Int. Cl. G02F 1/1335; B29D 7/01; B29C 55/00; G02B 5/30; C08L 1/10

(52) U.S. Cl. CPC G02F 1/133528; G02B 5/3083; C08L 1/10; B29C 55/005; B29D 7/01; B29K 2001/12
USPC 349/96; 359/489.07; 428/220; 106/162.7; 264/40.1

(57) ABSTRACT

A cellulose acylate film that contains at least one kind of cellulose acylate that has a substitution degree of an acyl group that contains an aromatic group of from 0.1 to 2.0, or a substitution degree of an acyl group having from 2 to 4 carbon atoms of from 2.0 to 2.6, and has an in-plane retardation at a wavelength of 550 nm Re(550) of from 80 to 350 nm, and the number of bright spots caused from irregular retardation regions having a major axis diameter of from 0.01 to 0.05 mm of 500 or less per 1 cm² causes less light leakage irrespective of Re of 80 nm or more, so as to enhance the display capability of IPS type and FFS type liquid crystal display devices.

### CROSS-REFERENCE TO RELATED APPLICATIONS

This application is a continuation application of International Application No. PCT/JP2013/057046, filed Mar. 13, 2013, which in turn claims the benefit of priority from Japanese Application No. 2012-081901, filed Mar. 30, 2012, the disclosures of which applications are incorporated by reference herein in their entirety.

### BACKGROUND OF THE INVENTION

1. Field of the Invention

The present invention relates to a cellulose acylate film and a method for producing the cellulose acylate film.

2. Background Art

IPS (in-plane switching) type and FFS (fringe field switching) type liquid crystal display devices show small luminance and color changes depending on the viewing angle because of the characteristics of the homogeneous orientation of the liquid crystal molecules in the liquid crystal cell, and are therefore starting to be applied to industrial use where high image quality is demanded, and to consumer use as high image quality display devices. In particular, the liquid crystal display devices are being often used as a liquid crystal display devices represented by a tablet terminal due to such points as the absence of unevenness on pressing in the use as a touch panel and the small color change depending on the viewing angle, as compared to a VA (vertical alignment) type liquid display device and the like.

In the IPS type and FFS type liquid crystal display devices, such embodiments have also been known that optical compensation is performed with a phase difference film for enhancing the image quality and the contrast (see, for example, Patent Literatures 1 and 2).

### CITATION LIST

### Patent Literatures

### Patent Literature 1: JP-A-2007-191505

### Patent Literature 2: JP-A-2007-279083

### Patent Literature 3: Japanese Patent No. 4,547,051

### Patent Literature 4: JP-A-2003-255136

### SUMMARY OF INVENTION

In recent years, display devices are becoming higher definition, for example, a so-called 4K2K display (3,840×2,160 pixels). This means reduction of the pixel size, particularly the aperture ratio thereof, due to the increase of the number of pixels per the same display size, which brings about the tendency that there are increasing requirements for the allowable defects of the constitutional components.

The known display defects that are caused by the optical film include point defects like bright spots due to solid particles, and it has been known that the point defects may be reduced by the methods described in Patent Literatures 3 and 4.

Various compensation methods for the IPS type and FFS type liquid crystal display devices have been known as described above, and a phase difference film that mainly has a large in-plane retardation value is often used.

An optically anisotropic layer utilizing a liquid crystal compound may also be applied thereto, but a stretching operation is necessarily performed for providing the high in-plane retardation value with the polymer film. It is thus necessary to consider a stretching operation with a higher stretching ratio for providing a particularly large in-plane retardation.

As a result of earnest investigations made by the present inventors, it has been found that a film that is produced with a strong stretching operation has regions where the retardation is irregularly exhibited, around solid particles or the like. The regions have a larger size than the nuclei, i.e., the solid particles or the like, and are observed as many bright spots with a special shape having a major axis diameter as large as from 0.01 to 0.05 mm in elliptical approximation as shown in FIG. 1. It has been found that the irregular retardation regions cause the light leakage and the image quality deterioration in the display devices.

An object of the invention is to solve the aforementioned problems, and to provide a cellulose acylate film that causes less light leakage irrespective of a high in-plane retardation value, so as to enhance the display capability of IPS type and FFS type liquid crystal display devices, and a method for producing the same.

As a result of further earnest investigations made by the inventors based on the aforementioned knowledge, it has been found that solid matters or gelled matters, which are derived from the raw materials or formed through deposition or aggregation in the production process, may be mixed as solid particles in the raw materials for forming the film, and accelerate aggregation of the substituents of cellulose acylate around the solid particles as nuclei under a strong stretching operation, thereby causing the region where the retardation Re is irregularly exhibited (i.e., the irregular retardation regions) around the solid particles as shown in FIG. 1, and the irregular retardation regions may cause light leakage. Thus, the invention has been completed. It has also been found that the aforementioned phenomenon may be conspicuously exhibited in a cellulose acylate film that has a substituent having an aromatic group, such as a benzoyl group, introduced therein, and the effect of the invention may be conspicuously exhibited.

The measures for solving the problem include the measure shown in the following item (1) and preferably the measures shown in the following items (2) to (14).

(1) A cellulose acylate film,

comprising at least one kind of cellulose acylate that has a substitution degree of an acyl group that contains an aromatic group of from 0.1 to 2.0, or a substitution degree of an aliphatic acyl group having from 2 to 4 carbon atoms of from 2.0 to 2.6,

having an in-plane retardation at a wavelength of 550 nm Re(550) of from 80 to 350 nm, and

wherein when two polarizing plates are disposed to form crossed nicols and the cellulose acylate film is inserted between the two polarizing plates to observe bright spots caused from irregular retardation regions having a major axis diameter of from 0.01 to 0.05 mm with a polarizing microscope, the number of the observed bright spots is 500 or less per 1 cm².

(2) The cellulose acylate film according to the item (1), wherein the irregular retardation region has a solid particle present at center thereof, and satisfies the relationship, L>2D, wherein D represents the diameter of the solid particle, and L represents the major axis of the irregular retardation region.

(3) The cellulose acylate film according to the item (1) or (2), wherein the in-plane retardation at a wavelength of 550 nm Re(550) is from 200 to 350 nm.

(4) The cellulose acylate film according to any one of the items (1) to (3), which has a thickness of from 20 to 60 μm.

(5) The cellulose acylate film according to any one of the items (1) to (4), which has a retardation in thickness direction at a wave length of 550 nm Rth(550) of from −50 to 50 nm.

(6) The cellulose acylate film according to any one of the items (2) to (5), which has a content of the solid particles of 1,000 ppm or less.

(7) The cellulose acylate film according to any one of the items (1) to (6), which contains, as a major component, a cellulose substituted with the acyl group that contains an aromatic group, wherein the acyl group that contains an aromatic group is a substituent represented by the following formula (I):

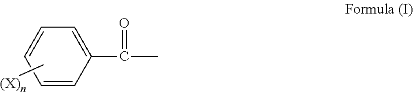

wherein X represents a hydrogen atom or a substituent, and n represents an integer of from 0 to 5, provided that when n is 2 or more, plural groups represented by X may be bonded to each other to form a condensed polycyclic ring.

(8) The cellulose acylate film according to anyone of the items (1) to (7), wherein the number of bright spots is 400 or less per 1 cm².

(9) The cellulose acylate film according to any one of the items (1) to (8), which contains a cellulose acylate having the acyl group that contains an aromatic group and the aliphatic acyl group.

(10) A method for producing the cellulose acylate film according to any one of the items (1) to (9), containing:

dissolving a cellulose acylate in a solvent to prepare a dope;

filtering the dope with a filtering material having an absolute filtration accuracy of 0.005 mm or less and forming the dope into a film; and

stretching the thus-formed film in 40% or more at a stretching temperature of from 130 to 230° C. and a speed of 40 to 400% per minute.

(11) The method for producing the cellulose acylate film according to the item (10), wherein the dope has a total solid concentration of from 10 to 25% by mass.

(12) The method for producing the cellulose acylate film according to the item (10) or (11), wherein the dope is filtered with the filtering material at a temperature of from 30 to 90° C.

(13) A polarizing plate containing a polarizing film and the cellulose acylate film according to any one of the items (1) to (9).

(14) A liquid crystal display device containing the polarizing plate according to the item (13).

According to the invention, a cellulose acylate film is provided that causes less light leakage irrespective of a high in-plane retardation value, so as to enhance the display capability of IPS type and FFS type liquid crystal display devices, and a method for producing the same is also provided.

### BRIEF DESCRIPTION OF DRAWINGS

FIG. 1 is a photograph showing an example of an irregular retardation region.

FIG. 2 is an illustration showing the definition of the irregular retardation region.

### DESCRIPTION OF EMBODIMENTS

The invention will be described in detail below.

In the description, the numerals shown as the upper limit and the lower limit of the range are included in the range. The terms used herein will be described below.

Re(λ) and Rth(λ) represent an in-plane retardation and a retardation in thickness direction at a wavelength λ, respectively. Re(λ) may be measured with KOBRA 21ADH or WR (produced by Oji Scientific Instruments Co., Ltd.), in which light having a wavelength of λ nm is incident in the normal direction of the film. For selecting the measurement wavelength λ nm, the wavelength selecting filter may be exchanged manually, or the measured value may be converted with a program or the like. In the case where the film to be measured is expressed by a uniaxial or biaxial indicatrix, Rth(λ) may be calculated according to the following manner. The measurement method may be partially used in the measurement of the average tilt angle of the discotic liquid crystal molecules in the optically anisotropic layer on the side of the oriented film and the average tilt angle thereof on the opposite side.

Rth(λ) may be calculated in such a manner that Re(λ) is measured at 6 points in total with light having a wavelength nm incident in directions of from the normal direction to directions tilted therefrom with a step of 10° until 50° on one side thereof with the in-plane retardation axis (which is determined with KOBRA 21ADH or WR) as the tilt axis (rotation axis) (in the case where there is no retardation axis, an arbitrary direction in the film plane is used as the rotation axis), and Rth(λ) is calculated with KOBRA 21ADH or WR based on the retardation values thus measured, the assumed value of the average refractive index and the input thickness value. In the case of the aforementioned calculation for a film having a direction that provides a retardation value of zero at a certain tilt angle from the normal direction with the in-plane retardation axis as the rotation axis, the sign of the retardation value at a tilt angle that is larger than the tilt angle providing zero retardation value is inverted to the negative, and Rth(λ) is calculated with KOBRA 21ADH or WR. Rth(λ) may also be calculated in such a manner that the retardation value is measured in two directions that are arbitrarily tilted with the retardation axis as the tilt axis (rotation axis) (in the case where there is no retardation axis, an arbitrary direction in the film plane is used as the rotation axis), and Rth is calculated according to the following expressions (A) and (B) based on the retardation values thus measured, the assumed value of the average refractive index and the input thickness value.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Expression ( A )$$

Re(θ) represents the retardation value in a direction that it tilted by an angle θ from the normal direction. In the expression (A), nx represents the refractive index in the in-plane retardation axis direction, ny represents the refractive index in the direction that is perpendicular to nx, and nz represents the refractive index in the direction that is perpendicular to nx and ny. In the expression (A), d represents the thickness.

Rth=((nx+ny)/2−nz)×d Expression (B)

In the case where the film to be measured is not expressed by a uniaxial or biaxial indicatrix, i.e., a film having no optical axis, Rth(λ) is measured in the following manner. Re(λ) is measured at 11 points with light having a wavelength λ nm incident in directions tilted from the normal direction of the film by from −50° to +50° with a step of 10° with the in-plane retardation axis (which is determined with KOBRA 21ADH or WR) as the tilt axis (rotation axis), and Rth(λ) is calculated with KOBRA 21ADH or WR based on the retardation values thus measured, the assumed value of the average refractive index and the input thickness value. In the measurement, the assumed value of the average refractive index used may be the values described in Polymer Handbook (published by John Wiley & Sons, Inc.) and the brochures of various optical films. For a film with no known average refractive index, the refractive index thereof may be measured with an Abbe refractometer. The average refractive index values of the major optical films are exemplified: cellulose acylate (1.48), cycloolefin polymer (1.52), polycarbonate (1.59), polymethyl methacrylate (1.49), and polystyrene (1.59). KOBRA 21ADH or WR calculates nx, ny and nz by inputting the assumed value of the average refractive index and the thickness value. Based on nx, ny and nz thus calculated, Nz=(nx−nz)/(nx−ny) is further calculated.

### Cellulose Acylate Film

The cellulose acylate film of the invention contains a composition containing at least one kind of cellulose acylate having a substitution degree of an acyl group that contains an aromatic group (which may be hereinafter referred to as an aromatic acyl group) of from 0.1 to 2.0, or having an aliphatic acyl group of from 2 to 4 carbon atoms (which may be hereinafter referred to as an aliphatic acyl group) having a substitution degree of from 2.0 to 2.6, and has an in-plane retardation at a wavelength of 550 nm Re(550) of from 80 to 350 nm, and a number of bright spots caused from irregular retardation regions having a major axis diameter of from 0.01 to 0.05 mm of 500 or less per 1 cm².

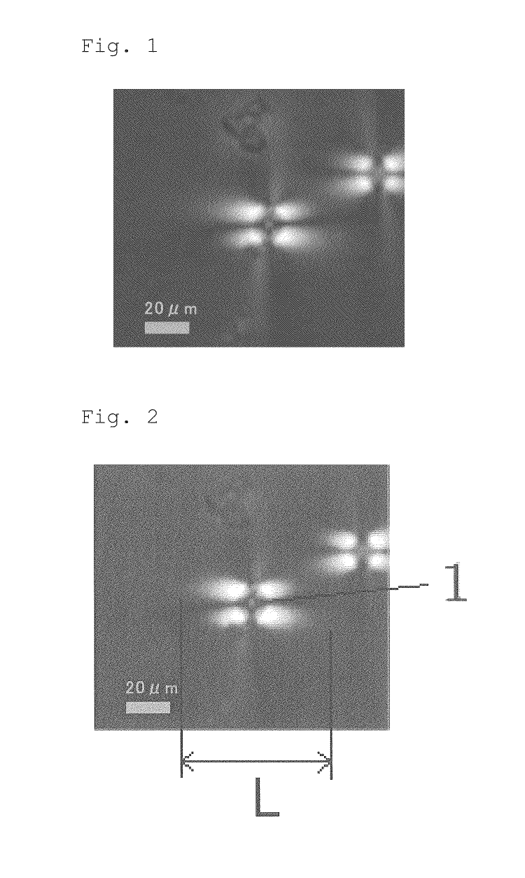

The irregular retardation region means a region including bright spots formed around a solid particle as shown in FIGS. 1 and 2, and specifically, a region having an elliptical shape that is approximated with a major axis L between the both ends of the bright spots and a minor axis that is adjusted to include all the bright spots observed in the region. In FIG. 1, the solid particle is present at the position that is surrounded by the four bright spots.

The number of bright spots caused from the irregular retardation regions may be obtained in such a manner that the cellulose acylate film is inserted between two polarizing plates disposed to form crossed nicols and observed with a polarizing microscope (magnification of objective lens: 50) to measure the number of bright spots per 1 cm².

The irregular retardation region preferably satisfies the relationship, L>2D, wherein L represents the major axis of the irregular retardation region, and D represents the diameter of the solid particle, more preferably satisfies the relationship, L>1.5D, and particularly preferably satisfies the relationship, L is nearly equal to D. When the relationship is satisfied, the contrast may be prevented from being reduced.

The number of bright spots caused from the irregular retardation regions is 500 or less, preferably 400 or less, and more preferably 300 or less, per 1 cm².

### Cellulose Acylate

The cellulose acylate has a substitution degree of an acyl group that contains an aromatic group of from 0.1 to 2.0, or a substitution degree of an aliphatic acyl group having from 2 to 4 carbon atoms of from 2.0 to 2.6. The substitution degree herein means the sum of the substitution degrees at the 2-position, the 3-position and the 6-position of the cellulose acylate.

Acyl Group that Contains Aromatic Group

The acyl group that contains an aromatic group in the invention may be bonded directly to the ester bond moiety or bonded thereto through a linking group, and is preferably bonded directly thereto.

The linking group herein may be an alkylene group, an alkenylene group or an alkynylene group, and the linking group may have a substituent. Preferred examples of the linking group include an alkylene group, an alkenylene group and an alkynylene group each having from 1 to 10 carbon atoms, more preferably an alkylene group and an alkenylene group each having from 1 to 6 carbon atoms, and particularly preferably an alkylene group and an alkenylene group each having from 1 to 4 carbon atoms.

It is expected that the irregular retardation region may be caused through the relationship between the surface of the solid particle and the cellulose acylate, and therefore, an aromatic acyl group is liable to be influenced due to the high bulkiness and the high activity thereof as compared to an aliphatic acyl group. Accordingly, as for a mixed acid ester of cellulose having both acyl groups, i.e., an aromatic acyl group and an aliphatic acyl group having from 2 to 4 carbon atoms, the substitution degree of an aromatic acyl group is dominant to the occurrence of the irregular retardation region, rather than the total substitution degree (the sum of the substitution degree of all acyl groups contained in the cellulose acylate), and thus the cellulose acylate having an aromatic acyl group is determined by paying attention to the substitution degree of an aromatic acyl group.

The aromatic group may have a substituent, and examples of the substituent substituted on the aromatic group and the substituent substituted on the linking group include the substituents described in paragraphs [0010] to [0013] of JP-A-2009-235374.

The aromatic acyl group is more preferably a substituent represented by the following formula (I):

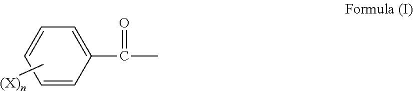

In the formula, X represents a hydrogen atom or a substituent, and n represents an integer of from 0 to 5. When n is 2 or more, plural groups represented by X may be bonded to each other to form a condensed polycyclic ring.

In the invention, an unsubstituted aromatic acyl group may be preferably used due to the easiness in the acylation process of cellulose and the handleability, and in the case where the aromatic acyl group is modified by further substituting, the substituent X used is preferably the substituents described in paragraphs [0005] to [0020] of Japanese Patent No. 4,065,696, and the description in paragraphs [0005] to [0020] of Japanese Patent No. 4,065,696 is incorporated herein by reference.

The acyl group that contains an aromatic group in the cellulose acylate may be formed of one kind thereof or two or more kinds thereof.

The substitution degree of the acyl group that contains an aromatic is from 0.1 to 2.0, preferably from 0.3 to 1.5, and more preferably from 0.5 to 1.3.

Examples of the substitution of the aromatic acyl group to the hydroxyl group of cellulose generally include a method using a symmetric acid anhydride and a mixed acid anhydride derived from an aromatic carboxylic acid chloride or an aromatic carboxylic acid. Particularly preferred examples thereof include a method using an acid anhydride derived from an aromatic carboxylic acid (described in Journal of Applied Polymer Science, vol. 29, pp. 3981-3990 (1984)).

### Aliphatic Acyl Group

The cellulose acylate may be formed only of an aliphatic acyl group, or may be a mixed acid ester of an aromatic acyl group and an aliphatic acyl group.

In the invention, plural kinds of the cellulose acylate may be used as a mixture, and the effects of the invention may be further exhibited by such an embodiment that the cellulose acylate having an aromatic acyl group is contained in an amount of 50 parts by mass or more to constitute a major component.

In the case where the cellulose acylate is formed only of an aliphatic acyl group in the invention, the aliphatic acyl group may be a linear, branched or cyclic aliphatic acyl group having from 2 to 4 carbon atoms, and may be an aliphatic acyl group having an unsaturated bond. Preferred examples of the aliphatic acyl group include an acetyl group, a propionyl group and a butylyl group, and an acetyl group is preferred among these. When the aliphatic acyl group is an acetyl group, a film that has a suitable glass transition point (Tg) and a suitable elastic modulus may be obtained. The use of an aliphatic acyl group having from 2 to 4 carbon atoms, such as an acetyl group, may provide a film that has a suitable strength without reduction of Tg and the elastic modulus.

The substitution degree in the case where only an aliphatic acyl group is contained is from 2.0 to 2.6, preferably from 2.1 to 2.6, and more preferably from 2.2 to 2.55.

In the case of the mixed acid ester of an aromatic acyl group and an aliphatic acyl group, it is preferred that the substitution degree of the aromatic acyl group is from 0.3 to 1.0, and the substitution degree of the aliphatic acyl group is from 0.1 to 2.5, and it is more preferred that the substitution degree of the aromatic acyl group is from 0.6 to 0.9, and the substitution degree of the aliphatic acyl group is from 1.5 to 2.3.

For the availability and the preparation method of the cellulose acylate, reference may be made to paragraphs [0021] to [0024] of JP-A-2009-235374, US-A-2010/0267942 and the like.

Inorganic impurities that are incorporated into the film on preparing the cellulose acylate of the invention, such as calcium, magnesium, phosphorus and boron, may be a remote cause of deposition, aggregation and the like, and thus the content of the inorganic impurities is preferably small. Specifically, the total content of inorganic impurities (solid particles) in the film is preferably 1,000 ppm or less, and more preferably 700 ppm or less.

While the solid particles due to the raw material may be removed in the filtering step described later, the reduction of the concentration of the inorganic impurities may suppress the direct deposition of the inorganic impurities and the deposition of the cellulose acylate composition that is caused indirectly by the inorganic impurities, and thus the formation of the irregular retardation region may be suppressed by suppressing the presence of the solid particles (i.e., the substance that becomes a so-called nucleus).

Specific examples of the cellulose acylate that is capable of being used in the invention are shown below, but the invention is not limited to the examples.

TABLE 1

| | | Substitution | | Substitution |
|---|---|---|---|---|
| | Aromatic | degree of aromatic | Aliphatic | degree of aliphatic |
| No. | acyl group | acyl group | acyl group | acyl group |
| A-1 | — | — | acetyl | 2.1 |
| A-2 | benzoyl | 0.9 | — | — |
| A-3 | benzoyl | 1.5 | — | — |
| A-4 | — | — | acetyl | 2.43 |
| A-5 | benzoyl | 0.75 | propionyl | 2.2 |
| A-6 | benzoyl | 0.7 | acetyl | 2.2 |
| A-7 | benzoyl | 1.0 | acetyl | 1.5 |
| A-8 | benzoyl | 0.7 | propionyl | 2.2 |
| A-9 | benzoyl | 1.0 | propionyl | 1.8 |
| A-10 | benzoyl | 0.8 | acetyl | 0.5 |
| | | | propionyl | 1.5 |

### Cellulose Acylate Composition

The cellulose acylate composition that is capable of being used in the invention will be described.

The cellulose acylate composition that may be utilized for producing the cellulose acylate film of the invention may contain at least one kind of the aforementioned cellulose acylate.

The cellulose acylate composition preferably contains the cellulose acylate in an amount of from 70 to 100% by mass, more preferably from 80 to 100% by mass, and further preferably from 90 to 100% by mass, based on the total composition.

The cellulose acylate composition may be in various forms, such as a particle form, a powder form, a fiber form, a bulk form, a solution and a molten material.

As a raw material for producing a film, a particle form or a powder form is preferred, and therefore, the cellulose acylate composition after drying may be pulverized or sieved for uniformizing the particle size and improving the handleability.

In the case where the cellulose acylate composition is formed into a film by a solvent casting method described later, the cellulose acylate composition may be used in the form of a dope formed by dissolving in a solvent.

In the invention, the cellulose acylate may be used solely or as a mixture of two or more kinds thereof. A polymer component other than the cellulose acylate and various additives may also be mixed appropriately therein. The component to be mixed preferably has good compatibility with the cellulose acylate and preferably makes a transmittance of the film of 80% or more, more preferably 90% or more, and particularly preferably 92% or more.

The cellulose acylate of the invention may contain various additives that may be generally added to cellulose acylate (such as an ultraviolet ray protecting agent, a plasticizer, an antiaging agent, fine particles and an optical property modifier) to form the composition. The time of adding the additives to the cellulose acylate may be any occasions in the production process of the dope, and the additives may be added in the final stage of the production process of the dope.

The amount of the additives added is preferably from 0.1 to 0.25 parts by mass.

A plasticizer may be used as an additive for controlling the mechanical properties and the processability of the film.

A plasticizer that has good compatibility with the cellulose acylate may be effective for providing a film having high quality and high durability since the plasticizer may not cause bleed-out, may provide low haze, and may reduce the water content and the moisture permeability.

The plasticizer that may be used in the cellulose acylate film is not particularly limited, and examples thereof include a phosphate ester plasticizer, a phthalate ester plasticizer, a polyhydric alcohol ester plasticizer, a polybasic carboxylate ester plasticizer, a glycolate plasticizer, a citrate ester plasticizer, a fatty acid ester plasticizer, a carboxylate ester plasticizer, a polyester oligomer plasticizer, a sugar ester plasticizer and an ethylenic unsaturated monomer copolymer plasticizer. Preferred examples thereof include a phosphate ester plasticizer, a phthalate ester plasticizer, a polyhydric alcohol ester plasticizer, a polyester oligomer plasticizer, a sugar ester plasticizer and an ethylenic unsaturated monomer copolymer plasticizer, more preferred examples thereof include a polyhydric alcohol ester plasticizer, a polyester oligomer plasticizer and a sugar ester plasticizer, further preferred examples thereof include a polyester oligomer plasticizer and a sugar ester plasticizer, and particularly preferred examples thereof include a polyester oligomer plasticizer.

In the invention, the plasticizer may be used solely or as a mixture of two or more kinds thereof.

The content of the plasticizer is preferably from 0.1 to 50% by mass, more preferably from 1 to 30% by mass, further preferably from 5 to 20% by mass, and particularly preferably from 7 to 15% by mass, based on the cellulose acylate.

Re and Rth of the cellulose acylate film of the invention may be controlled mainly by the substitution degree distribution of an aromatic acyl group and an aliphatic acyl group at the 2-position, the 3-position and the 6-position, and the stretching ratio. Specifically, the cellulose acylate film of the invention has Re(550) of from 80 to 350 nm, and preferably from 200 to 350 nm, and preferably has Rth(550) of from −50 to 50 nm, and more preferably from −30 to 40 nm. The cellulose acylate film preferably has such characteristics that exhibit an Nz value of approximately 0.5 (specifically from 0.25 to 0.65). The optical characteristics of the cellulose acylate film of the invention are not limited to these ranges.

The dispersion of the Re(550) value in the width direction of the film is preferably ±5 nm, and more preferably ±3 nm. The dispersion of the Rth(550) value in the width direction is preferably ±10 nm, and more preferably ±5 nm. The dispersions of the Re value and the Rth value in the longitudinal direction are preferably within the dispersion ranges of the width direction.

### Method for Producing Cellulose Acylate Film

The method for producing a cellulose acylate film of the invention contains: dissolving a cellulose acylate in a solvent to prepare a dope; filtering the dope with a filtering material having an absolute filtration accuracy of 0.005 mm or less and forming the dope into a film; and stretching the thus-formed film in 40% or more at a stretching temperature of from 130 to 230° C. and a speed of 40% per minute.

It has been ordinarily sufficient that only solid particles having such a size that is recognized as a bright spot or a dark spot shielding light are removed by filtration to a moderate extent, but in the invention, a severe filtration condition as compared to the ordinary methods may be required since the irregular retardation region determined in the invention may occur on a solid particle as a nucleus and over a surrounding larger region than the size of the solid particle, and thus may occur with a solid particle that is not recognized as a bright spot or the like.

The production method of the cellulose acylate film of the invention is not particularly limited, and the cellulose acylate film is preferably produced by a solvent casting method or a melt film forming method described later, and preferably by a solvent casting method. For the melt film forming method for forming the cellulose acylate film, reference may be made, for example, to JP-A-2006-348123, and for the solvent casting method therefor, reference may be made, for example, to JP-A-2006-241433.

In the method for producing a cellulose acylate film of the invention, a cellulose acylate is dissolved in a solvent to prepare a dope. In the invention, the cellulose acylate film is preferably produced by a solvent casting method, and specifically a dope prepared by dissolving a polymer in an organic solvent is cast on a surface of a support formed of a metal or the like, and then dried to form a film. Thereafter, the film is released from the surface of the support and then stretched to complete the production.

### Solvent Casting Film Formation

In the solvent casting method, a solution of a cellulose acylate is prepared, and the solution is flow-cast on a surface of a support to form a film. The solvent used for preparing the cellulose acylate solution is not particularly limited. Preferred examples of the solvent include a chlorine organic solvent, such as dichloromethane, chloroform, 1,2-dichloroethane and tetrachloroethylene, and non-chlorine organic solvent. The non-chlorine organic solvent is preferably selected from esters, ketones and ethers each having from 3 to 12 carbon atoms. The esters, ketones and ethers may have a cyclic structure. A compound having any two or more of functional groups of an ester, a ketone and an ether (i.e., —O—, —CO— and —COO—) may be used as a main solvent, and the solvent may have other functional groups, such as an alcoholic hydroxyl group. In the case of the main solvent having two or more kinds of functional groups, the number of carbon atoms therein may be within the range for any of the compounds having the functional groups. Examples of the ester compound having from 3 to 12 carbon atoms include ethyl formate, propyl formate, pentyl formate, methyl acetate, ethyl acetate and pentyl acetate. Examples of the ketone compound having from 3 to 12 carbon atoms include acetone, methyl ethyl ketone, diethyl ketone, diisobutyl ketone, cyclopentanone, cyclohexanone and methylcyclohexanone. Examples of the ether compound having from 3 to 12 carbon atoms include diisopropyl ether, dimethoxymethane, dimethoxyethane, 1,4-dioxane, 1,3-dioxolane, tetrahydrofuran, anisole and phenetole. Examples of the organic solvent having two or more kinds of functional groups include 2-ethoxyethyl acetate, 2-methoxyethanol and 2-butoxyethanol.

In the preparation of the cellulose acylate solution, the cellulose acylate is preferably dissolved in an organic solvent in an amount of from 10 to 35% by mass, more preferably from 13 to 30% by mass, and particularly preferably from 15 to 28% by mass. The cellulose acylate solution that has a concentration in the range may be prepared by dissolving the cellulose acylate in the solvent to make the desired concentration, or may be prepared in such a manner that a solution having a low concentration (for example, from 9 to 14% by mass) is prepared and then concentrated to prepare a solution having the desired concentration. In alternative, a cellulose acylate solution having a high concentration may be prepared, and then various additives may be added thereto to prepare a cellulose acylate solution having the desired concentration.

In the preparation of the cellulose acylate solution (dope), the dissolving method is not particularly limited. The dissolving method may be performed at room temperature, a cooling dissolving method or a high-temperature dissolving method may be performed, and these methods may be used in combination. For the dissolving method, reference may be made to JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017 and JP-A-11-302388, which describe preparation methods of a cellulose acylate solution and are incorporated herein by reference. For the details of the preparation method using a non-chlorine solvent, reference may be made to JIII Journal of Technical Disclosure Monthly (No. 2001-1746, published on Mar. 15, 2001, Japan Institute of Invention and Innovation), pp. 22-25. In the process of the preparation of the cellulose acylate solution, such process steps as condensation, filtration or the like of the solution may be performed, and for the details thereof, reference may be made to JIII Journal of Technical Disclosure Monthly (No. 2001-1746, published on Mar. 15, 2001, Japan Institute of Invention and Innovation), p. 25. For solving the cellulose acylate at a high temperature, the temperature is higher than the boiling point of the organic solvent used in most cases, and thus a pressurized condition may be used therefor.

After the preparation of the dope, the dope is filtered with a filtering material having an absolute filtration accuracy of 0.005 mm or less for removing solid particles that cause the irregular retardation region. According to the procedure, the number of bright spots caused from the irregular retardation regions may be suppressed to 500 or less per 1 cm².

The absolute filtration accuracy of the filtering material is preferably 0.005 mm or less, and more preferably 0.004 mm or less, and the lower limit thereof may be substantially 0.001 mm or more while not particularly limited. When the absolute filtration accuracy is 0.005 mm or less, the filtration may be used as one of measures for suppressing the number of bright spots caused from the irregular retardation regions to 500 or less per 1 cm². In this case, a too small filtration accuracy is liable to cause clogging to deteriorate the productivity, and thus, in particular, the viscosity may be carefully managed. Accordingly, in addition to the filtering conditions, the concentration and the temperature, which influence the viscosity, may be carefully managed depending on the formulation of the composition.

The temperature on passing the dope through the filtering material is preferably from 30 to 90° C., more preferably from 32 to 80° C., and particularly preferably from 35 to 75° C. When the dope is filtered at a temperature of 30° C. or more, the dope may be reduced in viscosity and thus may be filtered efficiently, and when the dope is filtered at a temperature of 90° C. or less, the contents thereof may be prevented from being decomposed.

The total solid concentration in the dope on filtering is preferably from 10 to 25% by mass, more preferably from 12 to 24% by mass, and particularly preferably from 14 to 23% by mass.

### Specific Method for Solvent Casting Film Formation

As the method and the equipment for producing the cellulose acylate film of the invention, a solvent casting film forming method and a solvent casting film forming equipment that have been applied to the production of an ordinary cellulose acylate film may be used. A dope (cellulose acylate solution) prepared in a dissolution device (tank) is once stored in storing tank, and the dope is defoamed and filtered to complete the dope finally. The dope thus prepared is stored in such a condition that deposition of the solid content and formation of gel due to aggregation are prevented from occurring, and the dope is delivered from the dope delivery port to a pressure die, for example, through a pressure metering gear pump capable of delivering a solution quantitatively with high accuracy by the rotation number thereof. The dope is uniformly flow-cast from the nozzle (slit) of the pressure die onto a metal support of a flow-casting member running endlessly, and at the releasing point where the metal support makes approximately one round, the half dry dope film (which may be referred to as a web) is released from the metal support. While holding both the edges of the resulting web with clips to maintain the width thereof, the web is conveyed and dried with a tenter, conveyed with a group of rolls of a drying device to complete drying, and then wound in a prescribed length with a winder. The combination of the tenter and the group of rolls of the drying device may be modified depending on the purposes. In a solvent casting film forming method that is used for a silver halide photographic photosensitive material and a functional protective film for an electronic display, a coating equipment is often added for performing surface processing on the film, such as an undercoating layer, an antistatic layer, an antihalation layer, a protective layer and the like, in addition to the solvent casting film forming equipment. For the details of these process steps, reference may be made to JIII Journal of Technical Disclosure Monthly (No. 2001-1745, published on Mar. 15, 2001, Japan Institute of Invention and Innovation), pp. 25-30, which is classified into the flow-casting (including co-flow-casting), the metal support, the drying, the releasing, the stretching and the like.

### Stretching Treatment

The cellulose acylate film of the invention having been produced by the melt film forming method or a solvent casting method described above is then subjected to a stretching treatment for achieving Re(550) of from 80 to 350 nm.

The stretching treatment may be performed on-line during the film forming process, or may be performed off-line, i.e., the film having been completed may be once wound up and then stretched. Specifically, in the case of the melt film forming method, the film may be stretched during the film formation where the film is not completely cooled, or may be stretched after cooling completely.

The stretching treatment is performed at a temperature of from 130 to 230° C., preferably from 175 to 220° C., and more preferably from 180 to 210° C.

The stretching ratio is 40% or more, preferably from 40 to 120%, and more preferably from 50 to 110%. The upper limit thereof is not particularly limited and may be 120%. The stretching treatment may be performed in one stage or in multiple stages. The stretching ratio herein means a value obtained according to the following expression.

stretching ratio (%)=100×((length after stretching)−(length before stretching))/(length before stretching)

The stretching treatment may be performed by a known stretching method, such as a longitudinal stretching, a transverse stretching, and a combination of them. For the longitudinal stretching, (1) roll stretching (which may also be referred to as a free end stretching, in which a film is stretched in the longitudinal direction with two or more pairs of nip rolls having an outlet side roll with a larger circumferential velocity), (2) fixed end stretching (in which both edges of a film are held and conveyed rapidly in the longitudinal direction to stretch the film in the longitudinal direction), and the like may be employed. For the transverse stretching, tenter stretching (in which both edges of a film are held with chucks, which are spread in the transverse direction (i.e., the direction perpendicular to the longitudinal direction)), and the like may be employed. The longitudinal stretching and the transverse stretching may be performed solely (i.e., uniaxial stretching) or may be performed in combination (i.e., biaxial stretching). In the case of the biaxial stretching, the longitudinal stretching and the transverse stretching may be performed sequentially (i.e., sequential stretching) or may be performed simultaneously (i.e., simultaneous stretching).

The stretching speed for the longitudinal stretching and the transverse stretching is 40 to 400% per minute, preferably from 60 to 350% per minute, and more preferably from 100 to 300% per minute. In the case of the multiple stage stretching, the stretching speed herein means the average value of the stretching speeds of the stages.

Subsequent to the stretching, a relaxing treatment or the like may be performed for the purpose of releasing the internal stress due to stretching or the like. When the relaxing treatment is performed, the film is preferably relaxed in from 0 to 10% in the longitudinal or transverse direction. Subsequent to the stretching, thermal fixation is also preferably performed at from 150 to 250° C. for 1 second to 3 minutes.

The angle θ between the film forming direction (i.e., the longitudinal direction) and the slow axis of Re of the film is preferably as close as to 0°, +90° or −90°. Specifically, in the case of longitudinal stretching, the angle is preferably as close as to 0°, preferably 0±3°, more preferably 0±2°, and particularly preferably 0±1°. In the case of transverse stretching, the angle is preferably 90±3° or −90±3°, more preferably 90±2° or −90±2°, and particularly preferably 90±1° or −90±1°.

The stretching treatment may be performed during the film forming process or may be performed for the rolled film after completing the film formation. In the former case, the film containing the residual solvent may be stretched, and is preferably stretched with a residual solvent amount of from 2 to 30% by mass.

The thickness of the cellulose acylate film obtained after drying may vary depending on the purpose thereof, and is preferably from 20 to 60 μm, more preferably from 20 to 50 μm, and particularly preferably from 20 to 45 μm. The thickness of the film may be controlled by adjusting the total solid concentration in the dope, the slit width of the nozzle of the die, the extruding pressure from the die, the velocity of the metal support, and the like, to make the desired thickness.

The cellulose acylate film of the invention may be formed in the form of a long film. For example, the cellulose acylate film may be in the form of a wound long film having a width of from 0.5 to 3 m (preferably from 0.6 to 2.5 m, and more preferably from 0.8 to 2.2 m) and a length of from 100 to 10,000 m (preferably from 500 to 7,000 m, and more preferably from 1,000 to 6,000 m) per one roll. On winding up the film, at least one edge thereof is preferably subjected to a knurling treatment, and the width of knurling is preferably from 3 to 50 mm, and more preferably from 5 to 30 mm, and the height thereof is preferably from 0.5 to 500 μm, and more preferably from 1 to 200 μm. The knurling treatment may be performed by one-way pressing or double-way pressing.

The stretched cellulose acylate film may be used solely or may be used as a polarizing plate protective film functioning as an optical anisotropic layer, in combination with a polarizing plate, and the film may be used after providing a functional layer, such as a liquid crystal layer, a layer having a controlled refractive index (i.e., a low reflective layer) and a hardcoat layer, thereon.

A liquid crystal compound may be coated on the cellulose acylate film formed of an aliphatic acyl group to provide a liquid crystal compound layer.

The liquid crystal compound may be coated directly on the cellulose acylate film or may be coated on an oriented film. Examples of the oriented film include a material containing polyvinyl alcohol as a major component, and a material containing an acrylic resin as a major component.

The liquid crystal layer may be a coated layer, and specifically a layer obtained by fixing homeotropic orientation of a liquid crystal composition containing a rod-like liquid crystal as a major component. In the case where a low molecular weight rod-like liquid crystal is contained as it is in the layer, the major component of the layer is the rod-like liquid crystal, whereas in the case where a polymerizable rod-like liquid crystal is polymerized into a polymer and contained in the layer, the major component of the layer is the polymerized rod-like liquid crystal, and the SP value is calculated respectively. The SP value of rod-like liquid crystals is generally from 20 to 25. The major component of the liquid crystal compound layer may be selected from the rod-like liquid crystals to make the |ΔSP| value of 5.0 or less in relation to the SP value of the cellulose acylate formed of an aliphatic acyl group having from 2 to 4 carbon atoms.

For the rod-like liquid crystal capable of being used herein, reference may be made, for example, to paragraphs [0045] to [0066] of JP-A-2009-217256. For the usable additives, the usable oriented film, and the forming method of the homeotropic liquid crystal layer, reference may be made, for example, to paragraphs [0076] to [0079] of JP-A-2009-237421.

The thickness of the liquid crystal compound layer is not particularly limited. In the case where the layer is formed by coating, the thickness thereof is generally approximately from 0.5 to 20 μm (and preferably from 1.0 to 15 μm).

### Phase Difference Film

The cellulose acylate film of the invention has retardation, and thus may be used as a phase difference film.

The functional layers described in detail in JIII Journal of Technical Disclosure Monthly (No. 2001-1745, published on Mar. 15, 2001, Japan Institute of Invention and Innovation), pp. 32-45 are preferably combined with the cellulose acylate film of the invention. What are preferred among these are application of a polarizing film (i.e., formation of a polarizing plate), application of an optical compensation layer formed of a liquid crystal composition (i.e., an optical compensation film), and application of an antireflection layer (i.e., an antireflection film).

### Optical Compensation Film

The cellulose acylate film of the invention may be utilized for optical compensation of a liquid crystal display device, due to the retardation value thereof. In the case where the cellulose acylate film of the invention satisfies the optical characteristics required for optical compensation, the cellulose acylate film may be used as it is as an optical compensation film. The cellulose acylate film of the invention may be used as an optical compensation film after laminating with one or more other layers, such as an optical anisotropic layer formed by curing a liquid crystal composition, or a layer formed of a birefringent polymer film, in order to satisfy optical characteristics required for the optical compensation.

### Polarizing Plate

The invention also relates to a polarizing plate containing a polarizing film and two protective film holding the polarizing film, in which at least one of the two protective film is the cellulose acylate film of the invention. The cellulose acylate film may be adhered to the polarizing film as a part of an optical compensation film having optical anisotropic layer or a part of an antireflection film having an antireflection layer. In the case where another layer is contained, the surface of the cellulose acylate film of the invention is preferably adhered to the surface of the polarizing film. The polarizing plate may be produced with reference, for example, to JP-A-2006-241433.

### Image Display Device

The invention also relates to an image display device that contains at least one sheet of the cellulose acylate film of the invention. The cellulose acylate film of the invention may be used in the display device as a phase difference film or an optical compensation film, or a part of a polarizing plate, an optical compensation film, an antireflection film or the like.

### Liquid Crystal Display Device

The cellulose acylate film of the invention may be incorporated in a liquid crystal display device, as a phase difference film, or a polarizing plate, an optical compensation film or an antireflection film that contains the cellulose acylate film. Examples of the liquid crystal display device include an IPS type and an FFS type. The cellulose acylate film of the invention may be used in any of transmission type, reflection type and semi-transmission type liquid crystal display devices.

In the case where the cellulose acylate film of the invention is used in an IPS mode liquid crystal display device, one sheet of the cellulose acylate film is preferably disposed between the liquid crystal cell and the polarizing plate on the display surface side or the polarizing plate on the backlight side. The cellulose acylate film may be used as a protective film incorporated in the polarizing plate on the display surface side or the polarizing plate on the backlight side, and incorporated into a liquid crystal display device as one member of the polarizing plate, and thereby the cellulose acylate film is disposed between the liquid crystal cell and the polarizing film. By disposing one or more sheets of the cellulose acylate film of the invention at the aforementioned position, the IPS mode liquid crystal display device may be improved in display characteristics, and particularly the color shift as viewed in an oblique direction on displaying a black image may be reduced. In an embodiment where the cellulose acylate film of the invention is used for optical compensation of an IPS mode liquid crystal display device, the cellulose acylate film preferably has Rth of from −50 to 50 nm and Re of from 80 to 350 nm. The Nz value thereof is preferably approximately 0.5, and specifically the Nz value is preferably from 0.25 to 0.65. In this embodiment, the cellulose acylate film of the invention is preferably disposed in such a manner that the in-plane slow axis thereof is arranged in parallel or perpendicular to the absorption axis of the polarizing film on the display surface side (or the polarizing film on the backlight side).

### EXAMPLE

The invention will be described more specifically with reference to examples below. The materials, the reagents, the amounts and ratios of substances, the procedures, and the like in the examples may be appropriately modified unless they deviate from the substance of the invention. Accordingly, the invention is not construed as being limited to the specific examples.

### Synthesis Example 1

### Preparation of Cellulose Acylate

For the compounds B-1, A-1, B-2, A-4 and B-6 shown in the table below, a cellulose acylate was synthesized by the methods described in JP-A-10-45804 and JP-A-08-231761 and measured for the substitution degree thereof. Specifically, sulfuric acid (7.8 parts by mass per 100 parts by mass of cellulose) was added as a catalyst, and a carboxylic acid as a raw material of the acyl substituent was added, followed by performing acylation reaction at 40° C. At this time, the kind and the substitution degree of the acyl group were controlled by adjusting the kind and the amount of the carboxylic acid. After the acylation, ripening was performed at 40° C. The cellulose acylate was rinsed with acetone for removing the low molecular weight component therefrom.

### Synthesis Example 2

### Preparation of Cellulose Acylate Benzoate

For the compounds B-3, A-2, A-3 and B-4 shown in the table below, a cellulose acylate benzoate was synthesized by the method described in Japanese Patent No. 4,065,696. Specifically, trifluoroacetic anhydride was added as a catalyst, and a carboxylic acid as a raw material of the acyl substituent was added, followed by performing acylation reaction at 50° C. At this time, the kind and the substitution degree of the acyl group were controlled by adjusting the kind and the amount of the carboxylic acid. After completing the reaction, the reaction liquid was cooled to room temperature, and after adding dichloromethane thereto, the reaction liquid was slowly poured into methanol with stirring for reprecipitation. The resulting precipitate was collected by filtering, and thus the target compound was obtained.

### Synthesis Example 3

### Preparation of Example Compound A-5

The example compound A-5 was obtained according to the method described in paragraphs [0151] to [0153] of US-A-2010/0267942.

### Compound B-5

Ethyl cellulose (ETHOCEL Std 20) produced by Dow Chemical Company was used as a comparative compound B-5.

### Production Example 1

### Production of Cellulose Acylate Film

Cellulose acylate films shown in the table below were produced by the following method using the cellulose acylates thus prepared.

### Preparation of Cellulose Acylate Solution

The following materials were charged in a mixing tank and dissolved by heating under stirring, thereby preparing a solution containing a cellulose acylate solution. It was difficult to control the size and the amount of solid particles, and therefore monodisperse fine particles of polymethyl methacrylate having an average particle diameter of 5 μm (SSX-105, produced by Sekisui Plastics Co., Ltd.) were used as simulated solid particles.

| | |
|---|---|
| Cellulose acylate shown in table | 100 parts by mass |
| Methylene chloride (first solvent) | 402 parts by mass |
| Methanol (second solvent) | 60 parts by mass |
| Polyester additive A shown below | shown in table |
| Sugar ester additive B shown below | shown in table |
| Fine particles | shown in table |

### Additive A

TABLE 2

| | | Dicarboxylic acid units | | | | Glycol units | | | |
|---|---|---|---|---|---|---|---|---|---|
| | | Terephthalic | Phthalic | Adipic | Succinic | Ethylene | 1,2-propane- | | |
| | Molecular | acid | acid | acid | acid | glycol | diol | PG ratio | |
| | weight | (% by mol) | (% by mol) | (% by mol) | (% by mol) | (% by mol) | (% by mol) | (%) | Terminal |
| Ester 1 | 800 | 55 | 0 | 0 | 45 | 50 | 50 | 50 | Ac |

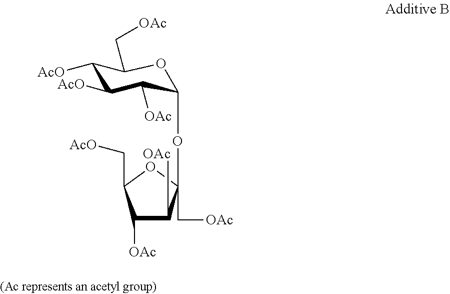

### Production of Cellulose Acylate Film Specimen

562 parts by mass of the solution having the cellulose acylate solution composition was filtered with filter paper having an absolute filtration accuracy (shown in the table below). The temperature on filtration was 40° C. Subsequently, the dope was flow-cast with a band flow-casting machine. The film having a residual solvent amount of 15% by mass was subjected to fixed end uniaxial stretching (free end uniaxial stretching in Comparative Example 7) in the stretching ratio shown in the table below, thereby producing the cellulose acylate films shown in the table below.

### Formation of Coated Layer

The surface of the film thus obtained above was subjected to a saponification treatment, and then a commercially available vertically oriented film (JALS-204R, produced by Japan Synthetic Rubber Co., Ltd.) was diluted with methyl ethyl ketone by 1/1 and coated on the film in 2.4 mL/m² with a wire bar coater. Immediately thereafter, the coated film was dried with warm air at 120° C. for 120 seconds, thereby forming a vertically oriented film.

A solution containing 1.8 g of the following rod-like liquid crystal compound, 0.06 g of a photopolymerization initiator (Irgacure 907, produced by Ciba-Geigy Co., Ltd.), 0.02 g of a sensitizing agent (Kayacure DETX, produced by Nippon Kayaku Co., Ltd.) and 0.002 g of the following vertical orientation agent on the air interface side, which were dissolved in 9.2 g of the solvent having the composition shown in the table below, was coated on the oriented film with a #2 wire bar coater. The film having the coated film was mounted on a metal flame and heated in a thermostat chamber at 100° C. for 2 minutes, so as to orient the rod-like liquid crystal compound. Subsequently, the rod-like liquid crystal compound was crosslinked by irradiating the compound with an ultraviolet ray at 100° C. for 30 seconds using a 120 W/cm high-pressure mercury lamp. Thereafter, the film was cooled to room temperature.

### Rod-like Liquid Crystal Compound

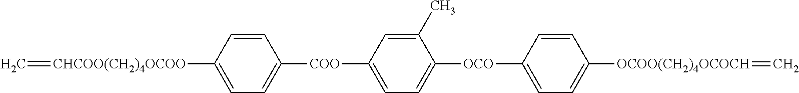

### Vertical Orientation Agent on Air Interface Side Example Compound (II-4) in Japanese Patent Application No. 2003-119959 (JP-A 2004-139015)

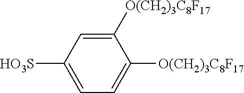

According to the procedures, a laminated film having the cellulose acylate film having thereon a coated layer containing a homeotropic liquid crystal layer was produced.

### Evaluation of Cellulose Acylate Film Specimen

In the evaluation of the film specimen, a part (120 mm×120 mm) of the film specimen obtained above was prepared and measured for the retardation values Re and Rth for light having a wavelength of 550 nm with KOBRA 12ADH (produced by Oji Scientific Instruments Co., Ltd.). The results are shown in the table below.

### Evaluation

The film was evaluated by measuring the panel contrast, the film contrast and the total evaluation of display capability of the assembled panel in the following manners. The results are shown in the table below.

### 1. Measurement of Bright Spots

Two polarizing plates were disposed to form crossed nicols, and the cellulose acylate film thus produced was inserted between them and observed with a polarizing microscope (magnification of objective lens: 50) to measure the number of bright spots per 1 cm². The polarizing plate was produced in the following manner.

Iodine was adsorbed on a stretched polyvinyl alcohol film to produce a polarizing film, and a commercially available cellulose acetate film (Fujitac TD80UF, produced by FUJIFILM Corporation, Re: 0 nm, Rth: 40 nm) was subjected to a saponification treatment and adhered to the polarizer with a polyvinyl alcohol adhesive, thereby producing a polarizing plate.

### 2. Measurement of Panel Contrast

The film adhered to the polarizing plate was adhered to an IPS panel (iPad 2, produced by Apple, Inc.), and evaluated for the panel contrast I_{w}/I_{b}, wherein I, represented the luminance on displaying a white image, and I_{b} represented the luminance on displaying a black image, by the following standard.

A: 800 or more
B: 650 or more and less than 800
C: less than 650

### 3. Measurement of Film Contrast

Polarizing plate having a polarizing capability of a polarization degree shown by the following expression of 99.995% of more were disposed to form crossed nicols, and the film was inserted between them and rotated for measuring the minimum transmittance (Imin). Thereafter, from the state where the minimum transmittance was observed, one of the polarizing plates was rotated by 90° to form parallel nicols, and the transmittance (Imax) in this state was measured. The film contrast (Imin)/(Imax) was evaluated by the following standard. A larger value of the film contrast means less light leakage.

P(%)=((Tp−Tc)/(Tp+Tc))^{1/2}×100

wherein Tp represents the transmittance in the state with parallel nicols, and To represents the transmittance in the state with crossed nicols.
A: 60,000 or more
B: 30,000 or more and less than 60,000
C: 30,000 or less

TABLE 3

| | | Substitution | Substitution | | | | | | |
|---|---|---|---|---|---|---|---|---|---|
| | | degree of | degree of | Additive | Stretching | Stretching | | | |
| | Film | aromatic | aliphatic | (part by | temperature | ratio | Thickness | Re | Rth |
| | No. | substituent | substituent | mass) | (° C.) | (%) | (μm) | (nm) | (nm) |
| Comparative Example 1 | B-1 | — | 1.9 | A (15) | 185 | 80 | 40 | 105 | 102 |
| Example 1 | A-1 | — | 2.1 | A (5) | 190 | 80 | 30 | 95 | 95 |
| | | | | B (3) | | | | | |
| Comparative Example 2 | B-2 | — | 2.7 | A (15) | 188 | 80 | 40 | 65 | 70 |
| Comparative Example 3 | B-3 | 0.05 | — | — | 200 | 80 | 40 | 65 | 55 |
| Example 2 | A-2 | 0.9 | — | C (2) | 200 | 80 | 40 | 250 | −100 |
| Example 3 | A-3 | 1.5 | — | C (2) | 200 | 80 | 40 | 340 | −140 |
| Comparative Example 4 | B-4 | 2.1 | — | — | 200 | 80 | 40 | 380 | −250 |
| Comparative Example 5 | A-4 | — | 2.43 | A (19) | 185 | 90 | 15 | 55 | 65 |
| Example 4 | A-4 | — | 2.43 | A (19) | 185 | 90 | 25 | 82 | 85 |
| Example 5 | A-4 | — | 2.43 | A (19) | 185 | 60 | 41 | 100 | 110 |
| | | | | D (4) | | | | | |
| Example 6 | A-4 | — | 2.43 | A (19) | 178 | 75 | 55 | 90 | 120 |
| Comparative Example 6 | A-4 | — | 2.43 | A (19) | 185 | 90 | 65 | 100 | 100 |
| Example 7 | A-5 | 0.75 | 2.20 | — | 202 | 70 | 45 | 220 | 10 |
| Example 8 | A-5 | 0.75 | 2.20 | — | 202 | 80 | 45 | 250 | 10 |
| Example 9 | A-5 | 0.75 | 2.20 | — | 202 | 90 | 45 | 280 | 10 |
| Example 10 | A-5 | 0.75 | 2.20 | — | 202 | 100 | 50 | 340 | 10 |
| Comparative Example 7 | B-5 | — | — | — | 140 | 30 | 44 | 360 | 300 |
| Example 11 | A-5 | 0.75 | 2.20 | — | 202 | 90 | 45 | 280 | 10 |
| Example 12 | A-5 | 0.75 | 2.20 | — | 202 | 90 | 45 | 280 | 10 |
| Comparative Example 8 | A-5 | 0.75 | 2.20 | — | 202 | 90 | 45 | 280 | 10 |
| Comparative Example 9 | B-6 | — | 2.85 | TPP (11.3) | — | — | 60 | 0 | 40 |
| | | | | BDP (11.3) | | | | | |
| Comparative Example 10 | B-6 | — | 2.85 | TPP (11.3) | — | — | 60 | 0 | 40 |
| | | | | BDP (11.3) | | | | | |
| Comparative Example 11 | A-5 | 0.75 | 2.20 | — | — | — | 50 | 0 | −70 |
| Comparative Example 12 | A-4 | — | 2.43 | A (19) | — | — | 50 | 0 | 120 |

| | Coated layer | | | | Number of | Absolute | Fine particles | | | Evaluation |
|---|---|---|---|---|---|---|---|---|---|---|
| | | Thickness | Re | Rth | bright | filtration | (part by | Film | Panel | of assembled |
| | Kind | (μm) | (nm) | (nm) | spots | accuracy | mass) | CR | CR | panel |
| Comparative Example 1 | — | — | — | — | 650 | 0.01 | 0 | C | C | C |
| Example 1 | rod-like | 1.5 | 0.2 | −155 | 380 | 0.01 | 0 | B | A | A |
| Comparative Example 2 | — | — | — | — | 340 | 0.01 | 0 | B | B | C |
| Comparative Example 3 | — | — | — | — | 510 | 0.01 | 0 | B | B | C |
| Example 2 | — | — | — | — | 250 | 0.01 | 0 | A | A | B |
| Example 3 | — | — | — | — | 410 | 0.01 | 0 | B | A | B |
| Comparative Example 4 | — | — | — | — | 420 | 0.01 | 0 | B | B | C |
| Comparative Example 5 | rod-like | 0.8 | 0.1 | −84 | 340 | 0.01 | 0 | B | B | C |
| Example 4 | rod-like | 1.6 | 0.1 | −160 | 350 | 0.01 | 0 | B | A | A |
| Example 5 | rod-like | 1.4 | 0.1 | −170 | 240 | 0.01 | 0 | A | A | A |
| Example 6 | rod-like | 1.7 | 0.2 | −192 | 350 | 0.01 | 0 | A | A | A |
| Comparative Example 6 | rod-like | 1.7 | 0.2 | −192 | 510 | 0.01 | 0 | C | B | B |
| Example 7 | — | — | — | — | 210 | 0.01 | 0 | A | A | B |
| Example 8 | — | — | — | — | 220 | 0.01 | 0 | A | A | A |
| Example 9 | — | — | — | — | 240 | 0.01 | 0 | A | A | A |
| Example 10 | — | — | — | — | 220 | 0.01 | 0 | A | A | B |
| Comparative Example 7 | — | — | — | — | 1200 | 0.01 | 0 | C | C | C |
| Example 11 | — | — | — | — | 100 | 0.005 | 0 | A | A | A |
| Example 12 | — | — | — | — | 400 | 0.01 | 0.1 | B | B | A |
| Comparative Example 8 | — | — | — | — | 600 | 0.01 | 0.2 | C | C | A |
| Comparative Example 9 | — | — | — | — | 100 | 0.005 | 0 | A | A | C |
| Comparative Example 10 | — | — | — | — | 600 | 0.01 | 0.1 | A | A | C |
| Comparative Example 11 | — | — | — | — | 50 | 0.01 | 0 | A | B | C |
| Comparative Example 12 | — | — | — | — | 30 | 0.01 | 0 | A | B | C |

In the table, TPP represents triphenyl phosphate, and BDP represents biphenyldiphenyl phosphate.

In the table, additives C and D show the following compounds.

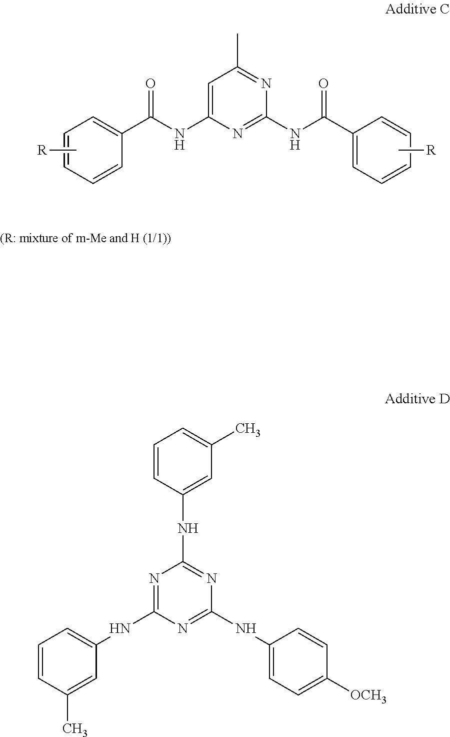

It is understood from the table that the cellulose acylate films that contain at least one kind of cellulose acylate that has an aromatic acyl group at a substitution degree of from 0.1 to 2.0, or an aliphatic acyl group at a substitution degree of from 2.0 to 2.6, and have an in-plane retardation at a wavelength of 550 nm Re(550) of from 80 to 350 nm, and a number of bright spots caused from irregular retardation regions having a major axis diameter of from 0.01 to 0.05 mm of 500 or less per 1 cm² are excellent in film contrast and panel contrast as compared to Comparative Examples.

### Production Example 2

### Production of IPS Mode Liquid Crystal Display Device

### Production of Polarizing Plate

### (1) Saponification of Film

The films produced in Examples and Comparative Examples and Fujitac (Fujitac T-40, produced by FUJIFILM Corporation) were immersed in a 1.5 mol/L sodium hydroxide aqueous solution (saponification solution) controlled to 55° C. for 2 minutes, and then the films were rinsed with water, then immersed in a 0.05 mol/mL sulfuric acid aqueous solution for 30 seconds, and further immersed in a water bath. Water was drained three times with an air knife for removing water from the film, and the film was dried by retaining in a drying zone at 70° C. for 15 seconds, thereby producing a saponified film.

### (2) Production of Polarizing Film

The film was stretched in the longitudinal direction with two pairs of nip rolls having a difference in circumferential velocity according to Example 1 of JP-A-2001-141926, thereby preparing a polarizing film having a thickness of 20 μm.

### (3) Adhesion

The saponified surface of the saponified films produced in Examples and Comparative Examples was adhered to one surface of the polarizing film obtained above with a 3% PVA solution (PVA-117H, produced by Kuraray Co., Ltd.) as an adhesive, and the saponified surface of T-40 was adhered to the other surface thereof. The films were adhered in such a manner that the absorption axis direction of the polarizing film and the slow axis direction of the film were perpendicular to each other.

### (4) Production of Liquid Crystal Display Device

The liquid crystal panel was taken out from the IPS panel (Model iPad 2, produced by Apple, Inc.), the upper polarizing plate (viewing side) of the optical films disposed on and below the liquid crystal cell was removed, and the glass surface of the liquid crystal cell was cleaned.

The film having been adhered to the polarizing plate was adhered to the display surface of the IPS mode liquid crystal cell to make the commercially available cellulose triacetate film outward. Thus, an IPS mode liquid crystal display device was produced.

### 4. Evaluation of Assembled Panel

A backlight was assembled to the IPS mode liquid crystal devices thus produced, and the devices displaying a black image were observed from the direction of a polar angle of 60° with respect to the front face with a measuring instrument (EZ-Contrast XL88, produced by ELDIM S.A.), and the index obtained by averaging the maximum ΔE values of the azimuth angle of from 0 to 90° (first quadrant), from 90 to 180° (second quadrant), from 180 to 270° (third quadrant) and from 270 to 360° (fourth quadrant) was designated as the color shift. The viewing angle CR was evaluated in such a manner that a backlight was assembled to the film, which was measured for the luminances on displaying a black image and displaying a white image in a darkroom with a measuring instrument (EZ-Contrast XL88, produced by ELDIM S.A.), and the average value of the minimum values in the direction of a polar angle of 60° in the quadrants, which was designated as a viewing angle contrast ratio (viewing angle CR), was calculated and evaluated by the following standard. The results are shown in Table 3. The classification was made based on the evaluation results of the color shift and the viewing angle CR.

A: The viewing angle CR was 100 or more with no practical problem. The color shift was small.
B: The viewing angle CR was 50 or more and less than 100 with substantially no practical problem. The color shift was slightly large but there was no practical problem.
C: The color shift was small, but the viewing angle CR was less than 50 causing a practical problem.

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2013/057046, filed Mar. 13, 2013, and Japanese Application No. 2012-081901, filed Mar. 30, 2012, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

### REFERENCE SIGN LIST

1 solid particle

What is claimed is:

1. A cellulose acylate film,
comprising at least one kind of cellulose acylate that has a substitution degree of an acyl group that contains an aromatic group of from 0.1 to 2.0, or a substitution degree of an aliphatic acyl group having from 2 to 4 carbon atoms of from 2.0 to 2.6,
having an in-plane retardation at a wavelength of 550 nm Re(550) of from 80 to 350 nm, and
wherein when two polarizing plates are disposed to form crossed nicols and the cellulose acylate film is inserted between the two polarizing plates to observe bright spots caused from irregular retardation regions having a major axis diameter of from 0.01 to 0.05 mm with a polarizing microscope, the number of the observed bright spots is 500 or less per 1 cm².

2. The cellulose acylate film according to claim 1, wherein the irregular retardation region has a solid particle present at center thereof, and satisfies the relationship, L>2D, wherein D represents the diameter of the solid particle, and L represents the major axis of the irregular retardation region.

3. The cellulose acylate film according to claim 1, having an in-plane retardation at a wavelength of 550 nm Re(550) of from 200 to 350 nm.

4. The cellulose acylate film according to claim 1, having a thickness of from 20 to 60 μm.

5. The cellulose acylate film according to claim 1, having a retardation in thickness direction at a wave length of 550 nm Rth(550) of from −50 to 50 nm.

6. The cellulose acylate film according to claim 2, having a content of the solid particles of 1,000 ppm or less.

7. The cellulose acylate film according to claim 1, which contains, as a major component, a cellulose substituted with the acyl group that contains an aromatic group, wherein the acyl group that contains an aromatic group is a substituent represented by the following formula (I): 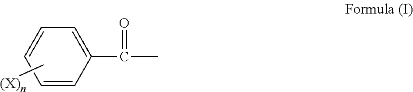
wherein X represents a hydrogen atom or a substituent, and n represents an integer of from 0 to 5, provided that when n is 2 or more, plural groups represented by X may be bonded to each other to form a condensed polycyclic ring.

8. The cellulose acylate film according to claim 1, wherein the number of bright spots is 400 or less per 1 cm².

9. The cellulose acylate film according to claim 1, which contains a cellulose acylate having the acyl group that contains an aromatic group and the aliphatic acyl group.

10. A method for producing a cellulose acylate film,
wherein the cellulose acylate film comprises at least one kind of cellulose acylate that has a substitution degree of an acyl group that contains an aromatic group of from 0.1 to 2.0, or a substitution degree of an aliphatic acyl group having from 2 to 4 carbon atoms of from 2.0 to 2.6; and the cellulose acylate film has an in-plane retardation at a wavelength of 550 nm Re(550) of from 80 to 350 nm; and when two polarizing plates are disposed to form crossed nicols and the cellulose acylate film is inserted between the two polarizing plates to observe bright spots caused from irregular retardation regions having a major axis diameter of from 0.01 to 0.05 mm with a polarizing microscope, the number of the observed bright spots is 500 or less per 1 cm², and
wherein the method comprises:
dissolving a cellulose acylate in a solvent to prepare a dope;
filtering the dope with a filtering material having an absolute filtration accuracy of 0.005 mm or less and forming the dope into a film; and
stretching the thus-formed film in 40% or more at a stretching temperature of from 130 to 230° C. and a speed of 40 to 400% per minute.

11. The method for producing the cellulose acylate film according to claim 10, wherein the dope has a total solid concentration of from 10 to 25% by mass.

12. The method for producing the cellulose acylate film according to claim 10, wherein the dope is filtered with the filtering material at a temperature of from 30 to 90° C.

13. A polarizing plate comprising a polarizing film and a cellulose acylate film,
wherein the cellulose acylate film comprises at least one kind of cellulose acylate that has a substitution degree of an acyl group that contains an aromatic group of from 0.1 to 2.0, or a substitution degree of an aliphatic acyl group having from 2 to 4 carbon atoms of from 2.0 to 2.6; and the cellulose acylate film has an in-plane retardation at a wavelength of 550 nm Re(550) of from 80 to 350 nm; and when two polarizing plates are disposed to form crossed nicols and the cellulose acylate film is inserted between the two polarizing plates to observe bright spots caused from irregular retardation regions having a major axis diameter of from 0.01 to 0.05 mm with a polarizing microscope, the number of the observed bright spots is 500 or less per 1 cm².

14. A liquid crystal display device comprising a polarizing plate,
wherein the polarizing plate comprises a polarizing film and a cellulose acylate film, and
wherein the cellulose acylate film comprises at least one kind of cellulose acylate that has a substitution degree of an acyl group that contains an aromatic group of from 0.1 to 2.0, or a substitution degree of an aliphatic acyl group having from 2 to 4 carbon atoms of from 2.0 to 2.6; and the cellulose acylate film has an in-plane retardation at a wavelength of 550 nm Re(550) of from 80 to 350 nm; and when two polarizing plates are disposed to form crossed nicols and the cellulose acylate film is inserted between the two polarizing plates to observe bright spots caused from irregular retardation regions having a major axis diameter of from 0.01 to 0.05 mm with a polarizing microscope, the number of the observed bright spots is 500 or less per 1 cm².
